(19) United States
(12) Patent Application Publication
(10) Pub. No.: US 2026/0255279 A1
(43) Pub. Date: Aug. 27, 2026

(54) COMMUNICATING POWER CONTROL STEP SIZE INFORMATION

(71) Applicant: Silicon Laboratories Inc., Austin, TX (US)

(72) Inventors: Charanteja Venati, Nellore (IN); Raviteja Sarvabhotla, Hyderabad (IN)

(21) Appl. No.: 19/065,270

(22) Filed: Feb. 27, 2025

(51) Int. Cl. H04W 52/36

(52) U.S. Cl. CPC H04W 52/362; H04W 52/367

(57) ABSTRACT

In one embodiment, a method includes: sending, from a first wireless device to a second wireless device, a first request for a step size setting of a power control change to be performed by the second wireless device; receiving, from the second wireless device, a first response to the first request, the first response comprising the step size setting of the power control change; and storing the step size setting in a storage of the first wireless device.

### BACKGROUND

Many wireless devices operate on battery power, and it is desirable to operate at low power consumption levels to prolong battery life. In certain wireless protocols, such as the Bluetooth protocol, it is possible for a receiving device to request that a corresponding transmitting device adjust its transmit power level if a received signal's characteristics differ too much from a desired value. Specifically, with respect to power control, a receiving device may request an increase or a decrease of the other device's transmit power level.

Such power control requests and corresponding responses reduce available communication times for regular wireless communications, such as data transfers or so forth. In some situations, a receiving device may issue a series of power control requests, even when a transmitting device has reached an end range of power control, e.g., a maximum power level or a minimum power level. These power control requests waste bandwidth and increase complexity.

### SUMMARY OF INVENTION

In one aspect, a method includes: sending, from a first wireless device to a second wireless device, a first request for a step size setting of a power control change to be performed by the second wireless device; receiving, from the second wireless device, a first response to the first request, the first response comprising the step size setting of the power control change; and storing the step size setting in a storage of the first wireless device.

In one implementation, the method further comprises: sending, from the first wireless device to the second wireless device, a second request for a power control change; and receiving, from the second wireless device, a second response to the second request. The method may further include, based at least in part on the step size setting and the second response, estimating a transmit power level of the second wireless device. Estimating the transmit power level of the second wireless device may further include measuring a power level of a radio frequency signal received in the first wireless device from the second wireless device.

In an implementation, the method may also include determining whether the estimated transmit power level of the second wireless device is within a threshold of a minimum power level or a maximum power level of the second wireless device. In response to determining that the estimated transmit power level of the second wireless device is within the threshold of the minimum power level or the maximum power level, additional power control requests are prevented from being sent to the second wireless device.

In an implementation, the method may also include: in response to determining that the estimated transmit power level of the second wireless device is not within the threshold, sending, from the first wireless device to the second wireless device, at least one additional request for another power control change; and receiving, from the second wireless device, at least one additional response to the at least one additional request for the another power control change.

In one implementation, the method may also include in response to receiving the second response comprising a maximum power indication or a minimum power indication, preventing additional power control requests from being sent to the second wireless device.

In another aspect, an apparatus includes: a wireless transceiver to transmit and receive radio frequency (RF) signals of at least a first wireless protocol; and a processor coupled to the wireless transceiver. The processor may include a link manager to manage link communications between the apparatus and a second apparatus, the link manager comprising a power manager to receive from the second apparatus a first request for a step size setting regarding a size change to a transmit power level of the RF signals, and in response to the first request, send a first response comprising the step size setting.

In one implementation, the apparatus may include a non-volatile storage to store the step size setting. The link manager may be configured to indicate to the second apparatus that the apparatus is configured to report the step size setting. The power manager, in response to a first request for a power control change from the second apparatus, may be configured to cause the wireless transceiver to update the transmit power level of the RF signals according to the step size setting. The link manager may be configured to send a second response to the second apparatus, the second response to confirm the update to the transmit power level of the RF signals. When the wireless transceiver has updated the transmit power level of the RF signals to a maximum level, the link manager may be configured to send the second response comprising an indication of the maximum level.

In an implementation, the power manager is to: send, to the second apparatus, a second request for a change to a transmit power level of the RF signals sent by the second apparatus; receive, from the second apparatus, a second response to the second request; and based at least in part on the second response and a step size setting of the second apparatus, estimate the transmit power level of the RF signals sent by the second apparatus.

In yet another aspect, a computer-readable storage medium includes instructions that when executed by at least one processor of a wireless device cause the wireless device to perform a method comprising: sending, from the wireless device to a second wireless device, a first request for a step size setting of a power control change to be performed by the second wireless device; receiving, from the second wireless device, a first response to the first request, the first response comprising the step size setting of the power control change; and storing the step size setting in a storage of the wireless device.

In one implementation, the method further comprises: sending to the second wireless device a second request for a power control change; and receiving from the second wireless device a second response to the second request. The method may also include estimating, based at least in part on the step size setting and the second response, a transmit power level of the second wireless device. Estimating the transmit power level of the second wireless device may further include measuring a power level of a radio frequency signal received in the wireless device from the second wireless device.

In an implementation, the method further includes, in response to determining that the estimated transmit power level of the second wireless device is within a threshold of a minimum power level or a maximum power level of the second wireless device, preventing additional power control requests from being sent to the second wireless device.

### BRIEF DESCRIPTION OF THE DRAWINGS

FIG. 1 is a timing diagram illustrating a number of communications in accordance with an embodiment.

FIG. 2 is a flow diagram of a method in accordance with an embodiment.

FIG. 3 is a flow diagram of a method in accordance with another embodiment.

FIG. 4 is a block diagram of a wireless environment in accordance with an embodiment.

FIG. 5 is a block diagram of a representative integrated circuit in accordance with an embodiment.

### DETAILED DESCRIPTION

In various embodiments, wireless devices in communication with each other can communicate information regarding a configured power control step size. By way of such communication, repeated power control requests can be avoided when a transmitting device is within at least a threshold distance of an end range of a transmit power level. Embodiments described herein are in the context of a particular wireless protocol, namely a Bluetooth Classic wireless protocol. However, understand that embodiments are not limited in this regard and in other implementations power control step size information may be communicated in other wireless protocols.

In one embodiment, a receiving device in communication with a transmitting device, prior to sending any power control requests to the transmitting device, can send a power control step size request. This power control step size request is sent by the receiving device in order to receive information regarding a step size setting of the transmitting device. Understand that this step size setting is a value indicative of an amount of power that the transmitting device updates its transmit power level in response to a single power control request.

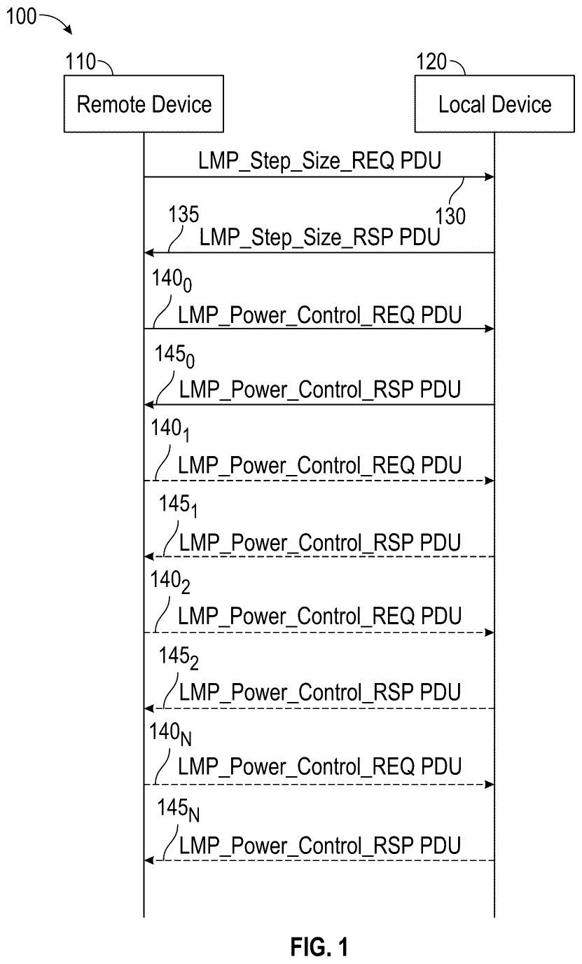

Referring now to FIG. 1, shown is a timing diagram illustrating a number of communications in accordance with an embodiment. As shown in FIG. 1, a remote device 110 is in communication with a local device 120. Understand for purposes of discussion that such remote and local devices can be any type of wireless device, and both devices are capable of transmitting and receiving information. In the context of FIG. 1, local device 120 is a device to have it transmit power controlled in response to a request from remote device 110.

As shown in FIG. 1, prior to transmission of any power control requests, remote device 110 sends a power control step size request to local device 120. In an embodiment for a Bluetooth implementation, this request may be a link manager protocol (LMP) step size request protocol data unit (PDU). Such PDU may be a defined message of a given Bluetooth specification. Or the request may be a custom or vendor-defined request to be handled by a receiving device having support for the request. In one or more embodiments, the devices may be configured to communicate their capability for handling step size requests as described herein.

In response to this request, local device 120 sends a power control step size response. In this Bluetooth implementation, this request may be a LMP step size response PDU. In this response, local device 120 indicates a step size setting having a value that is a step size of a power control change that it is to effect in response to a single power control request from the remote device. According to a Bluetooth specification, this step size may be a monotonic value between 2 decibels (dBs) to 8 dBs. In an embodiment, local device 120 may obtain the step size information from a configuration storage. In one implementation, this configuration storage may be a non-volatile memory of local device 120 in which various configuration settings of the device are stored.

Still referring to FIG. 1, after communication of this step size response to remote device 110, remote device 110 sends a plurality of power control requests. Each such power control request in this example causes a reduction in the transmit power level by one step. Understand that remote device 110 is configured to maintain information regarding an estimated power level of local device 120, based at least in part on step size information. In this way, remote device 110 may send one or more power control requests, so that local device 120 updates its transmit power level accordingly.

However, with the available information as to estimated power level of local device 120, remote device 110 does not send any further power control requests to local device 120, once the estimated power level of local device 120 is within at least a threshold distance of an end power range, e.g., a minimum or maximum power level of local device 120.

Thus, as shown in FIG. 1, once local device 120 sends a power control response that indicates that it is at a minimum power level (which may be communicated in the last power control response shown in FIG. 1), remote device 110 sends no further power control requests. Although shown at this high level in the embodiment of FIG. 1, many variations and alternatives are possible. For example, while FIG. 1 shows operations performed in reducing transmit power level, similar operations may be done in increasing transmit power level, until the transmitting device reaches a maximum power level. Also understand that step size requests can be initiated from both devices.

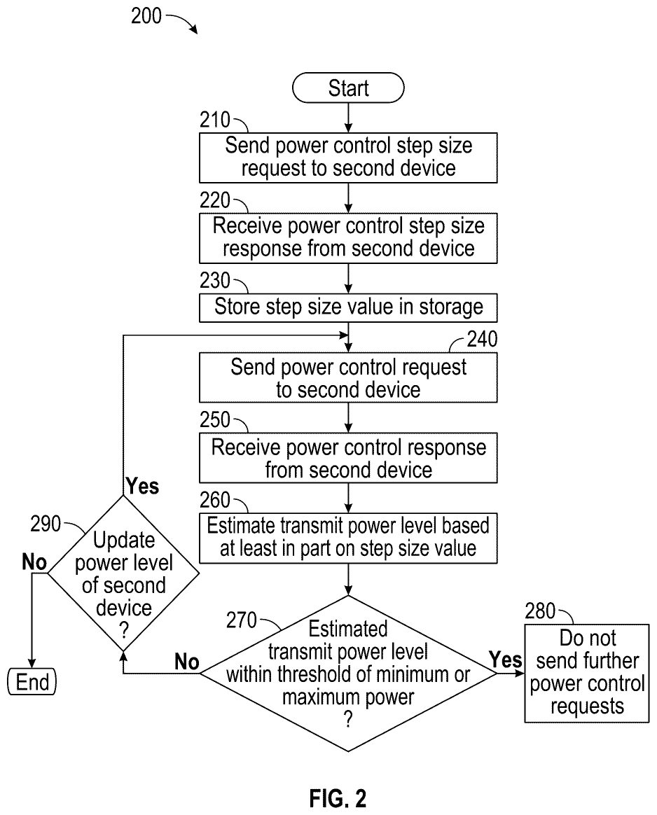

Referring now to FIG. 2, shown is a flow diagram of a method in accordance with an embodiment. As shown in FIG. 2, method 200 is a method for communicating a power control step size request from an initiating (first) device and using such information to reduce unnecessary power control requests. Method 200 may be performed by hardware of such device, such as a host processor or other hardware circuitry alone, and/or in combination with firmware and/or software. In a particular embodiment, a link manager of a Bluetooth controller of the first device may perform, at least in part, method 200. As illustrated, method 200 begins by sending a power control step size request to a second device (block 210). This second device may be another wireless device in communication with the first device.

Next at block 220, a response to this request is received from the second device. More specifically, the first device receives a power control step size response. As described herein, this response includes the step size setting for the second device, which indicates the size of a step change that the second device undergoes responsive to a given power control request. The first device may store this step size value in a storage, such as a buffer or other storage, e.g., a profile storage for the second device (block 230).

At this point, the first device is configured to monitor information regarding a power level of the second device, such that it can identify how much of a change in transmit power occurs for a given power control request. In this way, the first device can determine when the second device reaches a minimum or maximum transmit power level, such that the first device can avoid sending unnecessary power control requests.

Still with reference to FIG. 2, the first device may choose to send one or more power control requests to the second device. Specifically at block 240, the first device sends a first power control request to the second device, and responsive to this request, the second device sends a response, which the first device receives at block 250. Assume for purposes of discussion that the response indicates that the second device acknowledges and effects the power control change.

Still referring to FIG. 2, next at block 260 the first device estimates the transmit power level of the second device based at least in part on the step size value. As an example, the first device may include one or more power detectors coupled to one or more nodes of a receiver signal processing path to measure the power of a received RF signal as it is processed through this signal processing path. With this measurement information and knowledge of the step size, the first device can estimate transmit power level of the second device.

For example, assume that based on a measured power value from one or more points within this receiver signal processing path, the first device estimates that a previously received signal was at a power level of 10 dBm. With the further knowledge of the step size value of the second device, the first device can then estimate the transmit power level. Continuing with this example, assume that the second device has a step size of 3 dB; in this case, the first device estimates the transmit power level of the second device to be 7 dBm.

Still referring to FIG. 2, next at diamond 270 it is determined whether the estimated transmit power level is within a threshold of a minimum or maximum power level for the second device. Although embodiments are not limited in this regard, as an example this threshold may be equal to the step size setting. If it is determined that the transmit power is within this threshold, control passes to block 280. Accordingly, the first device does not send any further power control requests to the second device since the second device would be unable to accommodate these additional power control updates.

Instead, if it is determined that the estimated transmit power level is not within such threshold, control passes to diamond 290 where it is determined whether the first device seeks an additional update to the transmit power level of the second device. For example, such power level update may occur when the received RF signal is relatively noisy, e.g., due to channel conditions. In this instance, the first device may seek additional increase to the transmit power level of the second device and accordingly, control passes from diamond 290 back to block 240 discussed above. Understand while shown at this high level in the embodiment of FIG. 2, many variations and alternatives are possible.

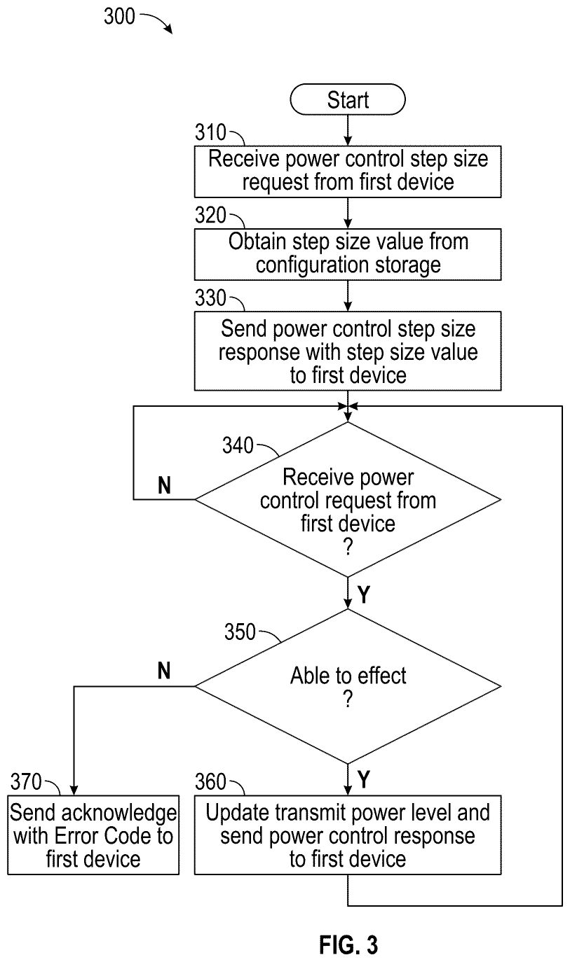

Referring now to FIG. 3, shown is a flow diagram of a method in accordance with another embodiment. As shown in FIG. 3, method 300 is a method for handling power control step size requests and power control requests in a receiving (second) device. Method 300 may be performed by hardware of such device, such as a host processor or other hardware circuitry alone, and/or in combination with firmware and/or software. In a particular embodiment, a link manager of a Bluetooth controller of the second device may perform, at least in part, method 300. As illustrated, method 300 begins by receiving a power control step size request from a first device (block 310), namely another wireless device in communication with the second device.

Then at block 320, the second device obtains this step size value from a storage, such as configuration storage that stores this value along with other configuration parameters for Bluetooth communications. In an embodiment, this configuration storage may be implemented in a non-volatile memory. Next at block 330, the second device prepares and sends a response to the step size request. More specifically, the second device generates and sends a power control step size response that indicates the size of the step change that the second device undergoes responsive to a given power control request.

Still referring to FIG. 3, next at diamond 340 it is determined whether a power control request is received from the first device. If so, at diamond 350 the second device determines whether it is able to effect a change. For example, the second device may confirm whether it has sufficient headroom to increase or decrease its transmit power within its end ranges, namely whether it is able to effect a step size change to its transmit power without exceeding either one of these end ranges. If it is not able to effect the change, control passes to block 370 where it sends an acknowledge message response back to the first device with an error code to indicate that it is not able to effect the power control change. Otherwise, when it is able to effect the change, control passes to block 360, where the second device updates its transmit power level and sends a power control response to the first device. Control then passes back to diamond 340 to determine whether additional power control requests are received. Although shown at this high level in the embodiment of FIG. 3, many variations and alternatives are possible.

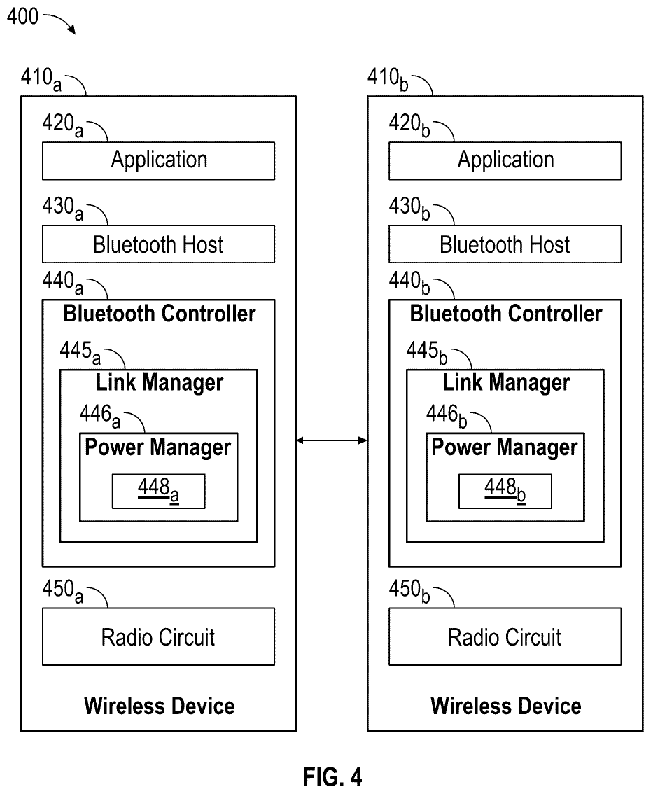

Referring now to FIG. 4, shown is a block diagram of a wireless environment in accordance with an embodiment. As shown in FIG. 4, wireless environment 400 includes a first wireless device 410ₐ and a second wireless device 410_{b}. In the embodiment of FIG. 4, assume that first device 410ₐ is a smartwatch that wirelessly couples to second device 410_{b}, implemented as a smartphone. Of course, in other cases these devices may be other types of IoT or other wireless devices. In the high level shown in FIG. 4, devices 410 include the same circuitry, and as such components of 410ₐ are discussed. Understand that similar components are present in second wireless device 410_{b}. Also understand that these devices may further include additional and/or different components as well, for implementing functionality of the given device.

In the high level shown in FIG. 4, device 410ₐ includes an application 420ₐ, which may be any type of user application that involves Bluetooth communications. To this end, application 420ₐ is in communication with a Bluetooth host 430ₐ, which may perform processing for a given Bluetooth communication protocol. In turn, Bluetooth host 430ₐ is in communication, e.g., via a host controller interface, with a Bluetooth controller 440ₐ. In an embodiment, device 410ₐ may include a baseband processor having host 430 and controller 440. In other embodiments, there can be different processors such as a host processor that implements a Bluetooth host and a baseband processor that implements a Bluetooth controller.

In the high level illustration of FIG. 4, Bluetooth controller 440ₐ includes a link manager 445ₐ, which is responsible for handling communications of a LMP. Link manager 445ₐ may send and receive various LMP communications. For purposes of embodiments, such communications include power control requests and step size communications as described herein.

To this end, link manager 445ₐ includes a power manager 446ₐ, which may effect power control communications. As illustrated, power manager 446ₐ includes a storage 448ₐ, which may store a step size setting for device 410ₐ. As described herein, this step size setting is a value of a power change that is to be effected responsive to a single power control request from a partner device, such as device 410_{b}. Although shown as included in power manager 446 for ease of discussion, storage 448 may be located elsewhere, such as within a flash or other non-volatile memory of device 410ₐ. Also understand that power manager 446ₐ also may obtain information regarding a step size setting of wireless device 410_{b}, and store such information, e.g., in a configuration profile for wireless device 410_{b}. With this information, wireless 410ₐ maintains information regarding a transmit power level of wireless device 410_{b} and prevents additional power control requests from being sent when device 410_{b} is at or near a maximum or minimum power level.

Still referring to FIG. 4, Bluetooth controller 440ₐ in turn is coupled to radio circuitry 450ₐ. In an embodiment, radio circuitry 450ₐ may be implemented as a multi-protocol wireless transceiver then includes circuitry to upconvert baseband signals to RF levels for transmission, and to downconvert received RF signals to baseband signals to pass to Bluetooth controller 440ₐ and/or Bluetooth host 430a. Although shown at this high level in the embodiment of FIG. 4, many variations and alternatives are possible.

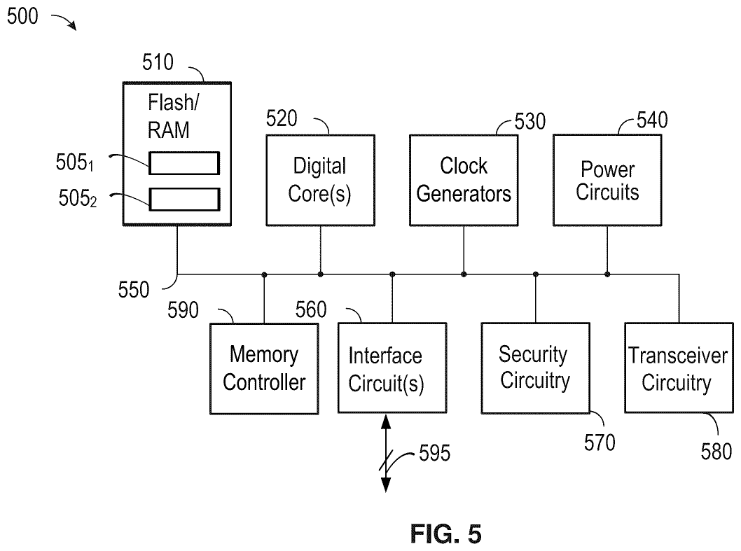

Referring now to FIG. 5, shown is a block diagram of a representative integrated circuit 500 that includes power control circuitry as described herein. In the embodiment shown in FIG. 5, integrated circuit 500 may be, e.g., a multi-mode wireless transceiver that may operate according to one or more wireless protocols or other device that can be used in a variety of use cases. In one or more embodiments, the circuitry of integrated circuit 500 shown in FIG. 5 may be implemented on a single semiconductor die or implemented on separate dies for wireless communication, MCU compute, external flash and/or other IP blocks needed to perform various functionalities.

Integrated circuit 500 may be included in a range of devices, but for purposes of discussion, it may be incorporated into an IoT device. In the embodiment shown, integrated circuit 500 includes a memory system 510 which in an embodiment may include volatile storage, such as RAM and non-volatile memory such as a flash memory. The flash memory is a non-transitory storage medium that can store instructions and data. These instructions include a set of instructions that, when executed, cause a step size request and/or response to be communicated and used to monitor a transmit power level of a remote device, to prevent unnecessary communication of power control requests when the remote device is already at a minimum or maximum power level, as described herein.

As further shown in FIG. 5, memory 510 may store configuration information in a configuration storage 505₁ having entries for various configuration information, including a step size setting for power control changes as described herein. As further shown, memory 510 includes a profile storage 505₂ to store profile information for one or more partner devices. As described herein, this profile information may include a step size setting, among other profile information. Integrated circuit 500 also may include a memory controller 590.

Memory system 510 couples via a bus 550 to one or more digital cores 520, which may include one or more cores and/or microcontrollers that act as processing units of the integrated circuit, and which may perform the power control operations as described herein. In turn, digital cores 520 may couple to clock generators 530 which may provide one or more phase locked loops or other clock generator circuitry to generate various clocks for use by circuitry of the IC.

As further illustrated, IC 500 further includes power circuitry 540. Additional circuitry may be present depending on particular implementation to provide various functionality and interaction with external devices. Such circuitry may include interface circuitry 560 which provides a digital communication interface with additional circuitry (such as another IC that can couple to IC 500 via a link 595). IC 500 also may include security circuitry 570 to perform wireless security techniques.

In addition, as shown in FIG. 5, transceiver circuitry 580 may be provided to enable transmission and reception of wireless signals, e.g., according to one or more of a local area or wide area wireless communication scheme, such as Matter, Zigbee, Bluetooth, IEEE 802.11, IEEE 802.15.4, cellular communication or so forth. Understand while shown with this high level view, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
sending, from a first wireless device to a second wireless device, a first request for a step size setting of a power control change to be performed by the second wireless device;
receiving, from the second wireless device, a first response to the first request, the first response comprising the step size setting of the power control change; and
storing the step size setting in a storage of the first wireless device.

2. The method of claim 1, further comprising:
sending, from the first wireless device to the second wireless device, a second request for a power control change; and
receiving, from the second wireless device, a second response to the second request.

3. The method of claim 2, further comprising based at least in part on the step size setting and the second response, estimating a transmit power level of the second wireless device.

4. The method of claim 3, wherein estimating the transmit power level of the second wireless device further comprises measuring a power level of a radio frequency signal received in the first wireless device from the second wireless device.

5. The method of claim 3, further comprising determining whether the estimated transmit power level of the second wireless device is within a threshold of a minimum power level or a maximum power level of the second wireless device.

6. The method of claim 5, further comprising in response to determining that the estimated transmit power level of the second wireless device is within the threshold of the minimum power level or the maximum power level, preventing additional power control requests from being sent to the second wireless device.

7. The method of claim 5, further comprising:
in response to determining that the estimated transmit power level of the second wireless device is not within the threshold, sending, from the first wireless device to the second wireless device, at least one additional request for another power control change; and
receiving, from the second wireless device, at least one additional response to the at least one additional request for the another power control change.

8. The method of claim 2, further comprising in response to receiving the second response comprising a maximum power indication or a minimum power indication, preventing additional power control requests from being sent to the second wireless device.

9. An apparatus comprising:
a wireless transceiver to transmit and receive radio frequency (RF) signals of at least a first wireless protocol; and
a processor coupled to the wireless transceiver, the processor comprising a link manager to manage link communications between the apparatus and a second apparatus, the link manager comprising a power manager to receive from the second apparatus a first request for a step size setting regarding a size change to a transmit power level of the RF signals, and in response to the first request, send a first response comprising the step size setting.

10. The apparatus of claim 9, further comprising a non-volatile storage, the non-volatile storage to store the step size setting.

11. The apparatus of claim 9, wherein the link manager is to indicate to the second apparatus that the apparatus is configured to report the step size setting.

12. The apparatus of claim 9, wherein the power manager, in response to a first request for a power control change from the second apparatus, is to cause the wireless transceiver to update the transmit power level of the RF signals according to the step size setting.

13. The apparatus of claim 12, wherein the link manager is to send a second response to the second apparatus, the second response to confirm the update to the transmit power level of the RF signals.

14. The apparatus of claim 13, wherein when the wireless transceiver has updated the transmit power level of the RF signals to a maximum level, the link manager is to send the second response comprising an indication of the maximum level.

15. The apparatus of claim 9, wherein the power manager is to:
send, to the second apparatus, a second request for a change to a transmit power level of the RF signals sent by the second apparatus;
receive, from the second apparatus, a second response to the second request; and
based at least in part on the second response and a step size setting of the second apparatus, estimate the transmit power level of the RF signals sent by the second apparatus.

16. A computer-readable storage medium comprising instructions that when executed by at least one processor of a wireless device cause the wireless device to perform a method comprising:
sending, from the wireless device to a second wireless device, a first request for a step size setting of a power control change to be performed by the second wireless device;
receiving, from the second wireless device, a first response to the first request, the first response comprising the step size setting of the power control change; and
storing the step size setting in a storage of the wireless device.

17. The computer-readable storage medium of claim 16, wherein the method further comprises:
sending to the second wireless device a second request for a power control change; and
receiving from the second wireless device a second response to the second request.

18. The computer-readable storage medium of claim 17, wherein the method further comprises estimating, based at least in part on the step size setting and the second response, a transmit power level of the second wireless device.

19. The computer-readable storage medium of claim 18, wherein estimating the transmit power level of the second wireless device further comprises measuring a power level of a radio frequency signal received in the wireless device from the second wireless device.

20. The computer-readable storage medium of claim 18, wherein the method further comprises in response to determining that the estimated transmit power level of the second wireless device is within a threshold of a minimum power level or a maximum power level of the second wireless device, preventing additional power control requests from being sent to the second wireless device.
